(19) United States
(12) Patent Application Publication
(10) Pub. No.: US 2023/0209153 A1
(43) Pub. Date: Jun. 29, 2023

(54) VIDEO IMAGING DEVICE WITH EMBEDDED COGNITION

(71) Applicant: EV-TECHNOLOGIES, COLOMBELLES (FR)

(72) Inventor: Sidina WANE, CAEN (FR)

(21) Appl. No.: 17/999,827

(22) PCT Filed: May 31, 2021
(86) PCT No.: PCT/EP2021/064578

§ 371 Date: Nov. 23, 2022

(30) Foreign Application Priority Data
May 29, 2020 (FR) 2005713

(51) Int. Cl. H04N 23/11; H04N 23/45; H04N 23/51; H04R 1/40

(52) U.S. Cl. CPC H04N 23/11; H04N 23/45; H04N 23/51; H04R 1/406

(57) ABSTRACT

The present disclosure relates to a video imaging device (10) comprising: at least one visual camera (11) comprising at least one visual image sensor sensitive to visible light and configured to capture a first scene (S) during a first capture period; at least one thermal camera (12) comprising at least one thermal image sensor sensitive to infrared light and configured to capture the first scene (S) during the first capture period; a video frame processing device (13) configured to determine an alignment between at least a first region of a first of the visual frames (20) with respect to at least a first region of a first of the thermal frames (21) based on correlation values representing correlations between pixels of the first visual and thermal frames.

The present patent application claims priority from the French patent application filed on 29 May 2020 and assigned application no. FR2005713, the contents of which is hereby incorporated by reference.

### TECHNICAL FIELD

The present disclosure relates generally to the field of video imaging cameras.

### BACKGROUND ART

Cooled and uncooled infrared cameras are capable of generating thermal images of an image scene. However, a drawback of such existing IR cameras is that they are relatively costly solutions and/or are unable to generate accurate 3D thermal maps. Additionally, thermal images may be difficult to interpret as they may not represent the reality as seen by a user with visible light.

### SUMMARY OF INVENTION

There is a need in the art for a video imaging device and method that at least partially address one or more drawbacks in the prior art.

Solutions are described in the following description, in the appended set of claims, and in the accompanying drawings.

One embodiment addresses all or some of the drawbacks of known video imaging cameras.

According to one aspect, there is provided a video imaging device comprising:

at least one visual camera comprising at least one visual image sensor sensitive to visible light and configured to capture a first scene during a first capture period;

at least one thermal camera comprising at least one thermal image sensor sensitive to infrared light and configured to capture the first scene during the first capture period;

a video frame processing device arranged to:

receive visual frames captured by the visual image sensor during the first capture period;

receive thermal frames captured by the thermal image sensor during the first capture period;

the video frame processing device being configured to determine an alignment between at least a first region of a first of the visual frames with respect to at least a first region of a first of the thermal frames based on correlation values representing correlations between pixels of the first visual and thermal frames.

According to one embodiment, prior to determining the alignment, the video frame processing device is configured to resize the visual frames and/or the thermal frames to have a same common size.

According to one embodiment, the video frame processing device is configured to: determine a plurality of first correlation values between first pixel values of pixels of the first region of one of the visual frames and first pixel values of pixels of the first region of a corresponding one of the thermal frames; and determine the alignment based on a determination of an average correlation displacement parameter determined based on said correlation values.

According to one embodiment, the video frame processing device is configured to: partition each visual frame into macro-pixels, each macro-pixel being generated based on a corresponding group of pixels of the visual frame; determine a plurality of second correlation values between second macro-pixel values of macro-pixels of the first region of one of the visual frames and pixel values of pixels of the first region of a corresponding one of the thermal frames; and determine the alignment based on a determination of an average correlation displacement parameter determined based on said second correlation values.

According to one embodiment, the video frame processing device is configured to:

partition each visual frame into macro-pixels, each macro-pixel being generated based on a corresponding group of pixels of the visual frame;

partition each thermal frame into macro-pixels, each macro-pixel being generated based on a corresponding group of pixels of the thermal frame;

determine a plurality of second correlation values between second macro-pixel values of macro-pixels of the first region of one of the visual frames and second macro-pixel values of macro-pixels of the first region of a corresponding one of the thermal frames; and

determine the alignment based on a determination of an average correlation displacement parameter determined based on said second correlation values.

According to one embodiment, the video frame processing device is arranged to:

determine a plurality of third correlations values between pixel values of first and second pixels of at least one of the macro-pixels of the first region of one of the visual frames.

According to one embodiment, the video frame processing device is arranged to generate video frames where at least the first region of the visual frames are aligned with respect to at least the first region of the thermal frames.

According to one embodiment, the video frame processing device is configured to:

determinate a state of emotion of a user placed in the first scene based on an analysis of the alignment of at least the first region of the visual frames with respect to at least the first region of the thermal frames.

According to one embodiment, at least one of the correlation values result from cross-correlations determined for example based on the following equation:

$${nCC}_{{I}_{{S}_{1}} {I}_{S 2}} ( τ ) = \frac{{\int }_{-}^{+} {I}_{{S}_{1}} ( t ) {I}_{{S}_{2}} ( t + τ ) dt}{\sqrt{{\int }_{-}^{+} {\vert {I}_{{S}_{1}} ( t ) \vert}^{2} dt {\int }_{-}^{+} {\vert {I}_{{S}_{2}} ( t ) \vert}^{2} dt}}$$

where τ is the average correlation displacement parameter, I_{S}_{₁} is a matrix of pixel values of the first region of the visual frame, I_{S}_{₂} is a matrix of pixel values of the first region of the thermal frame.

According to one embodiment, at least one of the correlation values results from Cardinal-sine based calculations performed by the video frame processing device.

According to one embodiment, the video frame processing device is configured to run a cross-entropy optimization of at least the aligned first region of the visual frames with respect to the first region of the thermal frames.

According to one embodiment, the video imaging device comprises a bracket permitting attachment of the video imaging device to one of the temples of a pair of glasses.

According to one embodiment, the video imaging device further comprising a directional microphone configured to adapt its direction of sound reception based on beam-forming, the video imaging device being configured to control the direction of sound reception based a location of a target identified in the first visual frame.

According to a further aspect, there is provided a pair of glasses comprising, attached to one of the temples, the above video imaging device.

According to one embodiment, the pair of glasses further comprises sound sensors configured to determine a localization of a sound source, the video frame processing device of the video imaging device being configured to determine an alignment between at least a first region of visual frames with respect to at least a first region of thermal frames and with respect to the localization of the said sound source.

According to a further aspect, there is provided a process of alignment of video frames, comprising:

capturing a first scene during a first capture period with at least one visual camera of a video imaging device comprising at least one visual image sensor sensitive to visible light;

capturing the first scene during the first capture period with at least one thermal camera of the video imaging device comprising at least one thermal image sensor sensitive to infrared light;

receiving, by a video frame processing device of the video imaging device, visual frames captured by the visual image sensor during the first capture period;

receiving, by the video frame processing device, thermal frames captured by the thermal image sensor during the first capture period; and

determining, by the video frame processing device, an alignment between at least a first region of a first of the visual frames with respect to at least a first region of a first of the thermal frames, based on correlation values representing correlations between pixels of the first visual and thermal frames.

According to one embodiment, the video frame processing device is configured to:

determine a plurality of first correlation values between first pixel values of pixels of the first region of one of the visual frames and first pixel values of pixels of the first region of a corresponding one of the thermal frames; and

determine the alignment based on a determination of an average correlation displacement parameter determined based on said correlations.

According to a further aspect, there is provided an imaging device comprising:

a dual-visual-camera comprising first and second visual image sensors each sensitive to visible light; and

a thermal camera comprising at least one thermal image sensor sensitive to infrared light.

According to one embodiment, the optical axes of the first and second visual image sensors and of the at least one thermal image sensor are not aligned with each other, the imaging device further comprising an image processing device configured to receive a first visual image captured by the first visual image sensor, a second visual image captured by the second visual image sensor, and at least one thermal image captured by the at least one thermal image sensor, and to determine a correspondence between at least some of the pixels of the first and second visual images with the at least one thermal image.

According to one embodiment, the imaging processing device is configured to determine the correspondence by performing one, some or all of:

a spatial auto-correlation on each image;

a cross-correlation between each pair of images;

a blind-deconvolution;

an algorithm involving artificial-intelligence.

According to one embodiment, the image processing device is configured to determine the correspondence between at least some of the pixels of the first and second visual images with the at least one thermal image based at least partially on the detection of a common object present in each image.

According to one embodiment, the image processing device is configured to generate a visual video stream and a thereto video stream, the video streams being synchronized with each other.

According to one embodiment, the thermal camera is a dual-thermal-camera, and wherein the at least one thermal image sensor comprises first and second thermal image sensors.

According to one embodiment, the at least one thermal image sensor comprises a cooled micro-bolometer array.

According to one embodiment, the at least one thermal image sensor comprises an uncooled micro-bolometer array.

According to one embodiment, the micro-bolometer array is sensitive to light have wavelengths in the range 10.3 to 10.7 μm.

According to a further aspect, there is provided a method of imaging comprising:

capturing visual images using a dual-visual-camera of an imaging device, the dual-visual-camera comprising first and second visual image sensors each sensitive to visible light; and

capturing thermal images using a thermal camera comprising at least one thermal image sensor sensitive to infrared light.

According to one embodiment, the optical axes of the first and second visual image sensors and of the at least one thermal image sensor are not aligned with each other, the method further comprising:

receiving, by an image processing device of the imaging device, a first visual image captured by the first visual image sensor, a second visual image captured by the second visual image sensor, and at least one thermal image captured by the at least one thermal image sensor; and

determining, by the image processing device, a correspondence between at least some of the pixels of the first and second visual images with the at least one thermal image.

According to one embodiment, determining the correspondence comprises performing one, some or all of:

a spatial auto-correlation on each image;

a cross-correlation between each pair of images;

a blind-deconvolution;

an algorithm involving artificial-intelligence.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1 schematically illustrates a video imaging device according to example embodiment of the present disclosure;

FIG. 2 represents captured image frames according to an embodiment of the present disclosure;

FIG. 3 is a flow diagram illustrating operations in a method of aligning visual and thermal images according to an embodiment of the present disclosure;

FIG. 4 is a flow diagram illustrating operations in a method of aligning visual and thermal images according to a further embodiment of the present disclosure;

FIG. 5A illustrates a thermal frame macro-pixel according to an example embodiment;

FIG. 5B illustrates a visual frame macro-pixel according to an example embodiment;

FIG. 5C illustrates an example of overlapping normalized correlations in a visual frame macro-pixel according to an example embodiment;

FIG. 6 schematically illustrates glasses equipped with a video imaging device according to an embodiment of the present disclosure; and

FIG. 7 represents infrared images of subjects at various states of emotion according to an embodiment of the present disclosure.

### DESCRIPTION OF EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures, or to a video imaging device as orientated during normal use.

Unless specified otherwise, the expressions “around”, “approximately”, “substantially” and “in the order of” signify within 10%, and preferably within 5%.

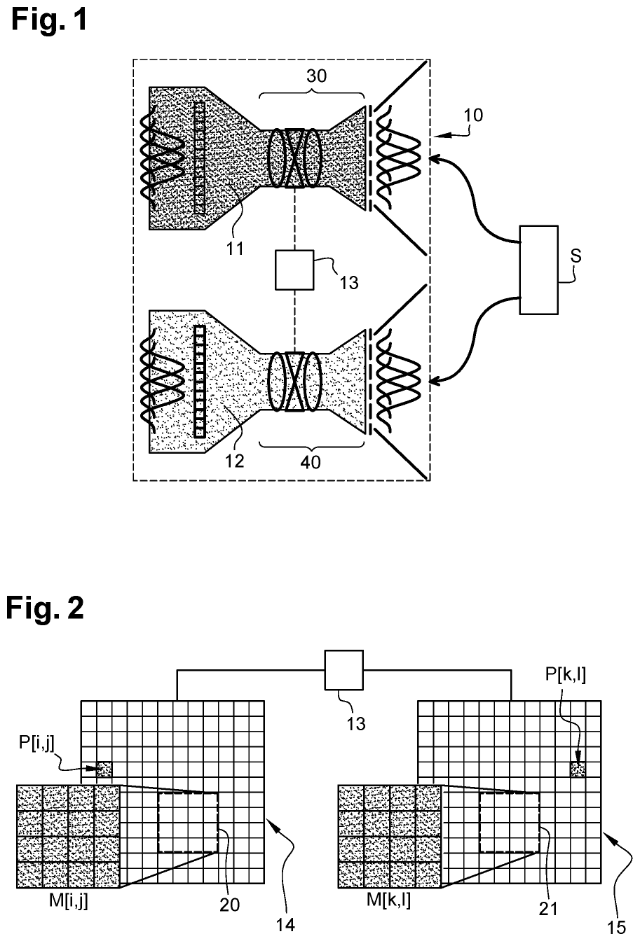

FIG. 1 is a schematic view of an embodiment of a video imaging device 10 of the present disclosure.

The video imaging device 10 of FIG. 1 comprises one visual camera 11, one thermal camera 12 and a video frame processing device 13. In alternative embodiments, the video imaging device 10 may comprise two or more visual cameras 11, and/or two or more thermal cameras 12, coupled to the video frame processing device 13.

The visual camera 11 comprises at least one visual image sensor, which is sensitive to visible light. By visible light, it should for example be understood light with wavelengths ranging from approximately 350 nanometers to approximately 750 nanometers. The visual image sensor may be, in one example, made of one or a plurality of photodiodes or optoelectronic sensors. For example, the visual image sensor comprises an array of pixel circuits, each pixel circuit comprising one or more photodiodes or optoelectronic sensors. In the case that the visual camera 11 is a color camera, at least some of the photodiodes are for example covered by a color filter. The visual image sensor is for example configured to capture a first scene S during a first capture period. The visual image sensor generates visual frames, which may be combined as video frames of a video stream by repeating the capture operation during subsequent capture periods. The visual frames are represented by pixels. For example, the visual frames comprise pixels P[i,j], where [i,j] represents the pixel location in frame. The pixels P[i,j] are for example indexed as a function of their relative position in each frame along two virtual perpendicular axes. Each pixel P[i,j] is for example composed of a single component, for example in the case of greyscale pixels, or of several components, for example in the case of color pixels. For example, in the case of color pixels, each pixel for example comprises red, green, and/or blue components, and/or other components, depending on the encoding scheme.

The thermal camera 12 for example comprises at least one thermal image sensor, which is sensitive to infrared light. By infrared light, it should for example be understood light with wavelengths superior to approximately 750 nanometers, and for example in the range of approximately 750 to 1400 nanometers. The thermal image sensor may be, in an example, made of one or a plurality of photodiodes or optoelectronic sensors. For example, the thermal image sensor comprises an array of pixel circuits, each pixel circuit comprising one or more photodiodes or optoelectronic sensors. The photodiodes or optoelectronic sensors are for example covered by a filter allowing only the infrared wavelengths to pass. Alternatively, other technologies of infrared camera could be employed, such as cameras based on microbolometers.

The thermal image sensor is for example configured to capture a first scene S during a first capture period. The thermal image sensor 12 generates thermal frames 15, which may be combined as video frames of a video stream by repeating the capture operation during subsequent capture periods. The thermal frames are represented by pixels P[k,l], where [k,l] represents the pixel location in frame. The pixels P[k,l] are for example indexed as a function of their relative position in each frame along two virtual perpendicular axes. Each pixel P[k,l] is for example composed of a single component, for example in the case of greyscale pixels, or of several components, for example in the case of color pixels. For example, in the case of color pixels, the colors are generated during a pre-processing operation of the pixels at the output of the thermal image sensor, for example in order to aid the visualization of the thermal information. In this case, each pixel for example comprises red, green, and/or blue components, or other components, depending on the encoding scheme.

The visual camera 11 and the thermal camera 12 may be arranged on the same side of a housing. In an example, the visual camera 11 and the thermal camera 12 are arranged as close as possible to each other to provide frames representing the first scene S from a point of view, which is similar for the two cameras. The visual camera 11 and the thermal camera 12 may comprise optical components like lenses 30, 40 in order to guide or transform the incoming light of the first scene S. The optical axes of the visual and thermal cameras are for example aligned so as to be substantially parallel to each other, or to converge to a common point at a given distance from the device 10, such as a distance of between 1 and 4 meters from the device 10.

The video frame processing device 13 of FIG. 1 is configured to receive the visual frames captured by the visual image sensor during the first capture period. The video frame processing device 13 is also configured to receive the thermal frames captured by the thermal image sensor during the first capture period. In an example, the video frame processing device 13 is implemented at least partially in hardware, for example by a specific ASIC (Application Specific Integrated Circuit), and/or by an FPGA (Field Programmable Gate Array). Additionally, or alternatively, the video frame processing device 14 is implemented at least partially in software, that is by instructions stored in a memory of the device and executed by a processor (not illustrated).

The use of separate visual and thermal cameras 11, 12, has advantages in terms of image quality and cost. Indeed, while there have been proposals for cameras capable of capturing both visual and thermal images, the quality of the images tends to be poor, and/or such a camera is excessively costly.

However, a problem of using separate visual and thermal cameras is that, in view of the misalignment between the optical axes of these cameras, the fields of view of the cameras are not identical, and thus the captured visual and thermal frames are not aligned with each other. Indeed, in view of the sizes of the image sensors of the visual and thermal cameras, a significant separation between the optical axes of these cameras cannot be avoided, this separation for example being of between 5 and 30 mm, and typically of around 20 mm. An additional challenge is that the resulting misalignment between the fields of view of the visual and thermal cameras is not constant, but varies as a function of the depth of field of the image scene that is being captured by the cameras.

For many applications, it would be desirable to be able to extract corresponding visual and thermal information in real-time from the captured frames. For example, in order to capture the body temperature of people in a crowd, it may be desired to identify in the visual images a forehead region of each person, and to identify from the thermal images a temperature reading of each forehead region. Additionally, or alternatively, it may be desired to generate an overlay image in which the visual and thermal frames are merged with accurate alignment in order to present, in a single video stream, both the visual and thermal information. For example, the thermal information in such an overlay image is represented using color ranges not naturally present in the visual images, thereby allowing a user to observe the visual and thermal information in tandem.

An image processing solution allowing a rapid and accurate determination of a realignment distance between visual and thermal images will now be described with reference to FIGS. 2 to 4.

FIG. 2 represents captured image frames according to an embodiment of the present disclosure. In this example, the video frame processing device 13 processes a first region of the visual frames 20 and a first region of the thermal frames 21. In another example (not illustrated), several regions of each of the visual frames 20 and of the thermal frames 21 may be processed in an alternating fashion or in parallel by the video frame processing device 13. The first regions of the visual frames 20 and of the thermal frames 21 may be chosen by those skilled in the art as a function of the calculation power of video frame processing device 13. In some cases, the regions may be of the same size as the visual frames and/or of the thermal frames.

The video frame processing device 13 is for example configured to determine an alignment along an axis of the first region of the visual frames 20 with respect to the first region of the thermal frames 21. In an example, the video frame processing device 13 may determine the alignment along the axis between several regions of the visual frames 20 with respect to several regions of the thermal frames 21.

The term “alignment” is used herein to designate a determined correspondence between pixels of the regions of the visual and thermal frames. For example, if one or more objects of the first scene are present in the visual frames and in the thermal frames, the video frame processing device 13 is for example configured to determine an alignment by determining a correspondence between the objects, and thus determining which pixels of the frames correspond. In other words, the video frame processing device 13 is able to detect and potentially overlay the common objects of the first regions of the visual frames and of the thermal frames. Indeed, in some embodiments, after determining the alignment, the video frame processing device 13 is configured to generate optical-IR overlay frames corresponding to a merging of at least some parts of the visual and thermal frames. This advantageously permits visual and thermal information to be represented in a same image and/or video stream.

In the example of FIG. 2, the video frame processing device 13 is for example configured to partition each visual frame 14 into macro-pixels M[i,j], and/or each of the thermal frames 15 into macro-pixels M[k,l]. Each macro-pixel M[i,j] is, for example, generated based on a corresponding group of pixels P[i,j] of the visual frame 14. The macro-pixels M[i,j] are indexed as a function of their relative position in each visual frame. Similarly, each macro-pixel M[k,l] is, for example, generated based on a corresponding group of pixels P[k,l] of the thermal frame 15. The macro-pixels M[k,l] are indexed as a function of their relative position in each thermal frame. As an example, if a captured frame comprises 1024 by 768 pixels, it is for example partitioned into 256 by 192 four-by-four macro-pixels.

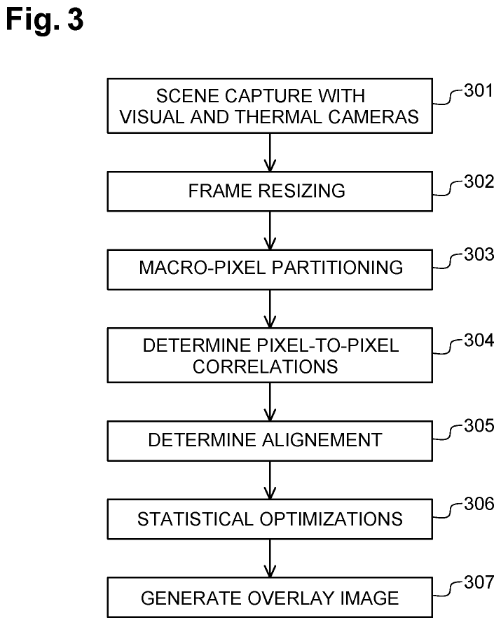

FIG. 3 is a flow diagram illustrating operations in a method of aligning visual and thermal images according to an embodiment of the present disclosure.

As already described in relation with FIG. 1, visual and thermal frames of the captured scene are firstly captured by the video imaging device 10, as represented by an operation 301 (SCENE CAPTURE WITH VISUAL AND THERMAL CAMERAS) of FIG. 3, and received by the video frames processing device 13. In the example of FIG. 3, the video frame processing device 13 is optionally configured to resize the visual frames 14 and/or the thermal frames 15 in an operation 302 (FRAME RESIZING) such that they have a same common size. This step is optional and may facilitate the signal processing.

Following the operations 301 and 302, the video frame processing device 13 is optionally configured to partition, in an operation 303 (MACRO-PIXEL PARTITIONING), the visual and/or thermal frames into macro-pixels, as described above in relation with FIG. 2. In some embodiments, in case of a difference in the resolutions between the visual and thermal frames, this partitioning allows a common resolution to be obtained.

In an operation 304 (DETERMINING PIXEL-TO-PIXEL CORRELATIONS), a plurality of pixel-to-pixel correlation values are for example determined between first pixel values of pixels P[i,j] of the first region of one of the visual frames and first pixel values of pixels P[k,l] of the first region of a corresponding one of the thermal frames. Here, corresponding regions are for example regions occupying same positions in the visual and thermal frames. The term “value” of pixel corresponds similarly to an intensity and for example to an intensity corresponding to each color contained in subpixels of the pixels, such as red, green or blue.

In an example, the various pixel intensities are transformed to be represented by gaussian curves.

The pixel-to-pixel correlations may be obtained by auto-correlations

$${nAC}_{{I}_{{S}_{1}} {I}_{{S}_{1}}} ( τ )$$

and/or cross-correlations

$${nAC}_{{I}_{{S}_{1}} {I}_{S 2}} ( τ ) ,$$

based for example on the following normalized equations (equations 1 and 2):

$${nAC}_{{I}_{{S}_{1}} {I}_{{S}_{1}}} ( τ ) = \frac{{\int }_{-}^{+} {I}_{{S}_{1}} ( t ) {I}_{{S}_{1}} ( t + τ ) dt}{\sqrt{{\int }_{-}^{+} {\vert {I}_{{S}_{1}} ( t ) \vert}^{2} dt {\int }_{-}^{+} {\vert {I}_{{S}_{1}} ( t ) \vert}^{2} dt}} \qquad [ Math 1 ]$$

where τ is the time lag, which will also be referred to herein as the correlation displacement parameter, and I_{S}_{₁} is a matrix of pixel values of an image region or entire frame for which the auto-correlation is to be determined.

$${nCC}_{{I}_{{S}_{1}} {I}_{S 2}} ( τ ) = \frac{{\int }_{-}^{+} {I}_{{S}_{1}} ( t ) {I}_{{S}_{2}} ( t + τ ) dt}{\sqrt{{\int }_{-}^{+} {\vert {I}_{{S}_{1}} ( t ) \vert}^{2} dt {\int }_{-}^{+} {\vert {I}_{{S}_{2}} ( t ) \vert}^{2} dt}} \qquad [ Math 2 ]$$

where I_{S}_{₁} is a matrix of pixel values of an image region or entire frame of one of the frames, for example one of the visual frames, and I_{S}_{₂} is a matrix of pixel values of an image region or entire frame of the other frames, for example one of the thermal frames, the correlation for example corresponding to an average value based on corresponding pixel-to-pixel correlations, for example generated based on each of the corresponding pixels P[i,j] and P[k,l].

In an operation 305 (DETERMINE ALIGNMENT), the alignment between the regions is for example determined based on an average amount of correlation determined based on the pixel-to-pixel correlation values calculated in operation 304. This for example involves determining the time lag T that leads to relatively high average pixel-to-pixel correlations. As the normalized correlations give a result between −1 and 1, if the average value of the pixel-to-pixel correlation is close to 1, this implies that an object (or a person) or at least a part of an object is similar in both the visual frames and the corresponding thermal frames. As will be understood by those skilled in the art, the average amount of correlation between the image regions can be used to determine the time lag, which in turn provides an indication by how much the pixels of the visual frames and the pixels of the thermal frames should be displaced to obtain a precise alignment between each other. It should be noted that the visual and thermal image sensors are for example considered to have a same fixed orientation with respect to each other, and thus the alignment to be determined for example corresponds to an alignment along only one axis, which is for example a common axis passing through the centers of the visual and thermal image sensors. Thus, based on the cross-correlations, it is possible to determine the amount of displacement to be applied to one of the image frames in order to determine a precise alignment.

In some embodiments, and in particular in the case that macro-pixel partitioning has been performed in the operation 303, the video frame processing device 13 is also configured to calculate during the operation 304, correlation values between macro-pixel values of macro-pixels M[i,j] of the first region of one of the visual frames and second macro-pixel values of macro-pixels M[k,l] of the first region of a corresponding one of the thermal frame. Similar equations 1 and 2 may be employed to obtain these macro-pixel correlation values except that the intensities correspond to the intensity of the macro-pixels.

In the case that macro-pixel correlation values are obtained in the operation 304, the operation 305 also for example involves determining the alignment based on the macro-pixel correlation values. Again, this for example involves determining the time lag or displacement T that leads to relatively high correlations. The time lag or displacement value provides an indication to the person of the art by how much the macro-pixels of the visual frames and the macro-pixels of the thermal frames should be displaced to obtain a precise alignment between each other.

In some cases, macro-pixel partitioning is applied in order to adapt the resolutions of the images. For example, if each pixel of the thermal sensor has a size that is four times the width and height of each pixel of the visual camera, generating the macro-pixels for only the visual frames and not the thermal frames permits pixels of the thermal frames to have a same resolution as the macro-pixels of the visual frames. The cross-correlation can then for example be calculated between the thermal pixels and the visual macro-pixels.

In some embodiments, the video frame processing device 13 is further configured to determine a plurality of pixel-to-pixel correlation values between pixel values of first and second pixels P[i,j] of each macro-pixel M[i,j] of the first region of the visual frames.

Similar equations as equations 1 and 2 may be employed to obtain these pixel-to-pixel correlation values within each macro-pixel.

With reference again to FIG. 3, in some embodiments the method comprises an operation 306 (STATISTICAL OPTIMIZATIONS), which for example involves performing cross-entropy optimizations, as will be described in more detail below.

In some embodiments, an operation 307 (GENERATE OVERLAY IMAGE) is also performed, in which an overlay image is generated based on the determined alignment between the visual and thermal images.

According to some embodiments of the present disclosure, rather that calculating correlations based only on the equations 1 and 2 above, these equations are applied only to a certain number of initial frames, and then a simplified Cardinal-sine based calculation is employed to simplify the implementation at least one of the types of correlations described above, as will now be explained in more detail.

In the vicinity of the origin, the Sine term can be approximated by its Taylor expansions as in the following expressions (equations 3, 4 and 5):

$$Sin C ( τ ) = \frac{Sin ( τ )}{τ} = {\sum }_{n = 1}^{n = ∞} {( - 1 )}^{n} \frac{{τ}^{2 n}}{( 2 n + 1 ) !} \qquad [ Math 3 ]$$

$$Sin C ( τ ) = 1 - \frac{{τ}^{2}}{3 !} + \frac{{τ}^{4}}{5 !} - \frac{{τ}^{6}}{7 !} … \qquad [ Math 4 ]$$

$$Sin C ( τ ) = {\prod }_{n = 1}^{∞} cos ( \frac{τ}{{2}^{n}} ) \qquad [ Math 5 ]$$

A simplified implementation is therefore possible in a portable equipment with a fast treatment and low consumption.

In an example, a Gaussian representation is employed for the pixels of the visual and thermal frames.

In this case it is possible to link the Cardinal-sine function to the Gaussian function as explained in the following expression (equation 6):

$$1 \sim {\sum }_{p = 0}^{P - 1} \frac{4}{( 2 p + 1 ) π} {( Sin C ( \frac{2 p + 1}{2 p} π ) )}^{k} sin ( ( 2 p + 1 ) τ ) \qquad [ Math 6 ]$$

where P is a parameter that depends on the order of the system, P for example being equal to 5 for a square function, and k is an optimization parameter depending on the.
It is further possible to introduce the functions B₀(t) and Bₘ as follows (equations 7, 8 and 9):

$${B}_{0} ( t ) := \{ \begin{matrix}1 , & for t ∈ [ - \frac{1}{2} , \frac{1}{2} ] \\ 0 , & else\end{matrix} . \qquad [ Math 7 ]$$

$${B}_{m} := {B}_{0} * {B}_{m - 1} , \\ m ∈ ℕ . \qquad [ Math 8 ]$$

$${B}_{m}^{\hat{}} ( ω ) = {sinc}^{( m + 1 )} ( ω / 2 ) \qquad [ Math 9 ]$$

where ω is the pulse frequency, equal for example to twice the pixel frequency.

The equations 7, 8 and 9 lead to the following expressions (equations 10 and 11):

$${lim}_{m \to ∞} \{ \sqrt{\frac{m + 1}{12}} {B}_{m} ( \sqrt{\frac{m + 1}{12}} \cdot x ) \} = \frac{1}{\sqrt{2 π}} exp ( - \frac{{x}^{2}}{2} ) \qquad [ Math 10 ]$$

$${lim}_{m \to ∞} \{ {( \frac{m + 1}{12} )}^{\frac{k + 1}{2}} {B}_{m}^{( k )} ( \sqrt{\frac{m + 1}{12}} \cdot x ) \} = \frac{1}{\sqrt{2 π}} \frac{{d}^{k} exp ( - \frac{{x}^{2}}{2} )}{{dx}^{k}} \qquad [ Math 11 ]$$

where k is the derivative order.

The equations 7 to 11 allow a simplified bridge between the Gaussian function representing the pixels with Cardinal-sine functions of the correlation calculations.

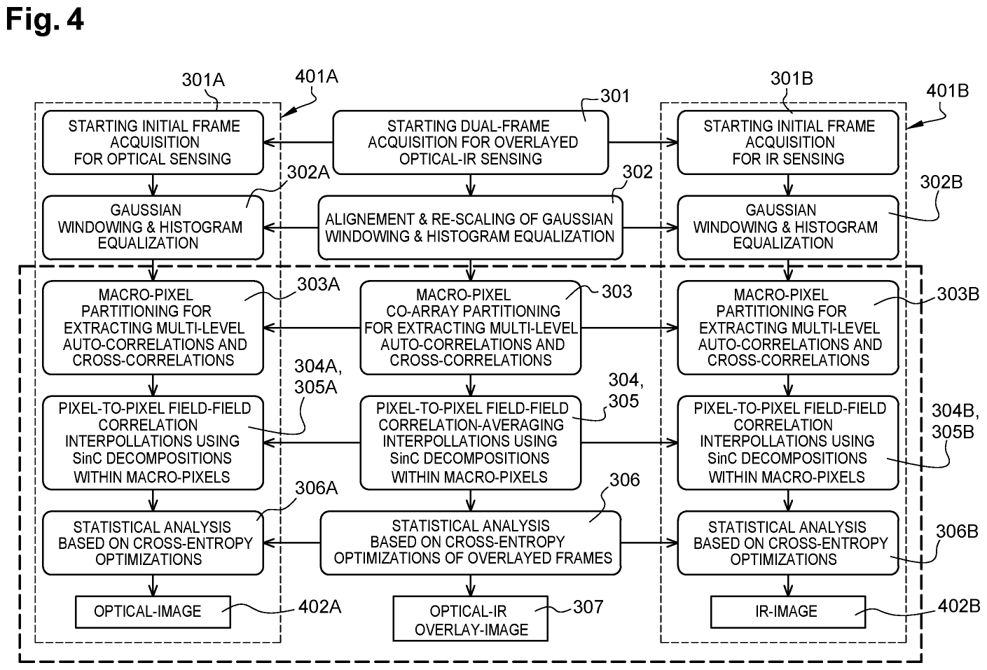

FIG. 4 is a flow diagram illustrating in more detail operations in a method of aligning visual and thermal images according to a further embodiment of the present disclosure. Operations similar to those of the method of FIG. 3 have been labelled with like reference numerals. The method of FIG. 4 is for example implemented by the video frame processing device 13.

In the example of FIG. 4, each of the operations of the method for example includes a corresponding operation of a process 401A applied to the visual images (referred to as optical images in the example of FIG. 4), and a corresponding operation of a process 401B applied to the thermal images (referred to as IR images in the example of FIG. 4).

The operation 301 (STARTING DUAL-FRAME ACQUISITION FOR OVERLAYED OPTICAL-IR SENSING) comprises, in the example of FIG. 4, an operation 301A (STARTING INITIAL FRAME ACQUISITION FOR OPTICAL SENSING) of the process 401A and an operation 301B (STARTING INITIAL FRAME ACQUISITION FOR IR SENSING) of the process 401B.

The operation 302 (ALIGNMENT & RE-SCALING OF GAUSSIAN WINDOWING & HISTOGRAM EQUALIZATION) comprises, in the example of FIG. 4, alignment and rescaling of Gaussian windowing and histogram equalization, as known by those skilled in the art. The operation comprises, in the example of FIG. 4, operations 302A and 302B (GAUSSIAN WINDOWING & HISTOGRAM EQUALIZATION) of the processes 401A and 401B respectively.

The operation 303 (MACRO-PIXEL CO-ARRAY PARTITIONING FOR EXTRACTING MULTI-LEVEL AUTO-CORRELATIONS AND CROSS-CORRELATIONS) involves macro-pixel co-array partitioning in order to extract, for example, multi-level auto-correlations and cross-correlations. This for example involves, in the example of FIG. 4, operations 303A and 303B (MACRO-PIXEL PARTITIONING FOR EXTRACTING MULTI-LEVEL AUTO-CORRELATIONS AND CROSS-CORRELATIONS) of the processes 401A and 401B respectively. By multi-level correlations, it is meant correlations at the pixel level and at the macro-pixel level.

The operations 304 and 305 (PIXEL-TO-PIXEL FIELD-FIELD CORRELATION-AVERAGING INTERPOLLATIONS USING SinC DECOMPOSITIONS WITHIN MACRO-PIXELS) involve, in the example of FIG. 4, pixel-to-pixel field-field correlation interpolations using SinC decompositions within macro-pixels, in order to determine the time lag, or displacement, separating the macro-pixels of the visual and thermal images. These operations for example comprise operations 304A, 305A and 304B, 305B (PIXEL-TO-PIXEL FIELD-FIELD CORRELATION INTERPOLLATIONS USING SinC DECOMPOSITIONS WITHIN MACRO-PIXELS) of the processes 401A and 401B respectively.

The operation 306 (STATISTICAL ANALYSIS BASED ON CROSS-ENTROPY OPTIMIZATIONS OF OVERLAYED FRAMES) for example comprises, in the example of FIG. 4, a statistical analysis based on cross-entropy optimizations of overlaid frames. The operation 306 for example comprises operations 306A, 306B (STATISTICAL ANALYSIS BASED ON CROSS-ENTROPY OPTIMIZATIONS) of the processes 401A and 401B respectively.

The operation 307 (OPTICAL-IR OVERLAY-IMAGE) in the example of FIG. 4 involves the generation of the overlay image, and in some embodiments, the process 401A further comprises an operation 402A (OPTICAL-IMAGE) in which the optical image resulting from the processing is output by the video frame processing device 13, and/or the process 401B further comprises an operation 402B (IR-IMAGE) in which the thermal image resulting from the processing is output by the video frame processing device 13.

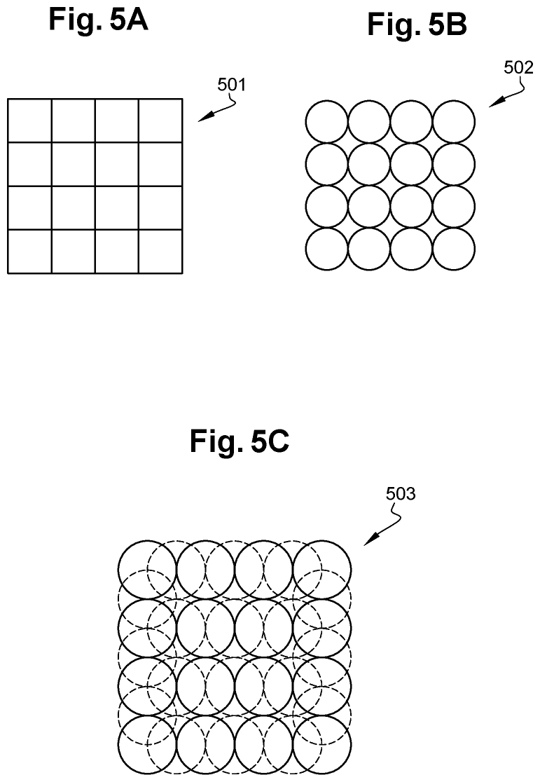

FIG. 5A illustrates a thermal frame macro-pixel 501 according to an example embodiment. As previously, in the example of FIG. 5A, the macro-pixel is based on a four-by-four group of pixels, i.e. four rows of four columns, although more generally it could be based on an m by m group of pixels, where m is for example equal to at least 2, and for example to between 2 and 16.

FIG. 5B illustrates a visual frame macro-pixel according to an example embodiment. The visual frame macro-pixel for example has the same dimensions as the thermal frame macro-pixel. In the example of FIG. 5B, the visual frame macro-pixel is a circle-sampling macro-pixel, meaning that, rather than having a square or rectangular shape, during pixelization, the pixel value is applied to a circular region with thus a relatively small pixel boundary.

FIG. 5C illustrates an example of overlapping normalized correlations 503 in a visual frame macro-pixel according to an example embodiment based on the circle-sampling macro-pixels of FIG. 5B. In particular, FIG. 5C illustrates the circle-sampling pixels of the macro-pixel, which are represented by continuous-line circles in FIG. 5C, and an example of cross-correlations generated based on these circle-sampling pixels, which are represented by dashed circles in FIG. 5C. For example, for each of the pixels around the edge of macro-pixel, cross-correlations are generated between each pixel and its nearest neighboring pixel around the edge. Thus, in the case of a four-by-four macro-pixel, twelve cross-correlation values are generated for the edge pixels. For each pixel that is not at an edge, cross-correlations are for example generated with respect to its neighboring pixels in the row, but not with respect to its neighboring pixels in the column. Thus, a further six correlation values are for example generated for these pixels in the four-by-four example. This leads to a total of 18 correlation values representing the sixteen pixels of the four-by-four macro-pixel. In some embodiments, these correlation values are used to replace the original pixel-value representation, as the original pixel information is not lost and it provides a low-noise encoding that occupies relatively little memory storage space. Indeed, during partitioning into macro-pixels, the original pixel values are for example replaced by a single macro-pixel value, by the cross-correlations permit the original information to be retrieved. For example, a single original pixel value, and normalized correlation values directly or indirectly linking this original pixel value to each of the other pixels of the macro-pixel, is enough to recuperate the original pixel information.

The correlation calculations of the disclosure allow efficient noise reductions as explained in the following equations. A non-normalized cross-correlation function may be expressed by a cross-correlation C_{AB}(τ) of stationary stochastic signals S_{A}(t) and S_{B}(t) such as the intensities of the different pixels. The cross-correlation is defined by the following equation where the brackets denote the ensemble average (equation 12):

$${C}_{AB} ( τ ) = 〈 {S}_{A} ( t ) \vert {S}_{B} ( t + τ ) 〉 = {lim}_{T \to } \frac{1}{2 T} {\int }_{- T / 2}^{+ T / 2} {S}_{A} ( t ) {S}_{B} ( t + τ ) dt \qquad [ Math 12 ]$$

where T is a period of measurement.

Assuming signals and noise contributions are uncorrelated, by applying the Esperance operator E[.] defined as first order statistical moment, the following relations can be derived (equation 13):

E[(S_{A}+N_{A})(̅S̅_̅{̅A̅}̅+̅N̅_̅{̅B̅}̅)̅]=E[|S_{A}|²]+E[S_{A}S̅_̅{̅B̅}̅]+E[S_{A}S̅_̅{̅A̅}̅]+E[N_{A}N̅_̅{̅B̅}̅]=E[|S_{B}|²]+E[S_{B}N̅_̅{̅A̅}̅]+E[N_{B}S̅_̅{̅B̅}̅]+E[N_{B}N̅_̅{̅A̅}̅]=E[|S_{A}|²]=E[|S_{B}|²] [Math 13]

where N_{A} and N_{B} are the noise contributions on the different pixels.

The equation 13 clearly shows that uncorrelated noise contributions are totally eliminated. For a given frame, the power spectra of the signals can be deduced from the correlation matrix c(t) (equation 14):

$$C ( t ) = ( \begin{matrix}{C}_{11} ( t ) & {C}_{12} ( t ) & … & {C}_{1 N} ( t ) \\ {C}_{21} ( t ) & {C}_{22} ( t ) & … & {C}_{2 N} ( t ) \\ ⋮ & ⋮ & … & ⋮ \\ {C}_{N 1} ( t ) & {C}_{N 2} ( t ) & … & {C}_{NN} ( t )\end{matrix} ) \qquad [ Math 14 ]$$

As described above in relation with FIGS. 3 and 4, in some embodiments the video frame processing device 13 is configured to perform cross-entropy optimization of at least the aligned first region of the visual frames 20 with respect to the first region of the thermal frames 21. The cross-entropy metrics are used for evaluating the accuracy of the stochastic measurements. The cross-entropy calculations may be described in the following equation (equation 15):

Cross-Entropy=−Σᵤ₌₀^{N}Σᵥ₌₀^{M}Iu,v log(Pu,v) [Math 15]

where, Iu,v denotes the true value i.e. 1 if sample u belongs to class v, and 0 otherwise, and Pu,v is the probability predicted of for sample u belonging to class v.

The cross-correlation functions are for example expressed as follows (equation 16):

$${CC}_{{I}_{{S}_{1}} {I}_{{S}_{2}}} = \frac{Cov ( {I}_{{S}_{1}} {I}_{{S}_{2}} )}{σ ( {I}_{{S}_{1}} ) σ ( {I}_{{S}_{2}} )} \qquad [ Math 16 ]$$

With (equation 17):

COV(I_{S}_{₁}I_{S}_{₂})=Σ[(I_{S}_{₁}−μ1)(I₂−μ2)] [Math 17]

where μi and σ(I_{S}_{ᵢ}) are the expectation and standard deviation of I_{S}_{ᵢ}. Here CC_{I}_{_{S1}}_{I}_{_{S2}} denotes a coefficient number in the interval [−1, +1]. The boundaries −1 and +1 will be reached if and only if I_{S}_{₁} and I_{S}_{₂} are indeed linearly related. The greater the absolute value of CC_{I}_{_{S1}}_{I}_{_{S2}}, the stronger the dependence between I_{S}_{₁} and I_{S}_{₂}.

In a non-illustrated example, the various correlation calculations and/or the cross-entropy calculations may be optimized by artificial intelligence processes.

In such a case, an artificial neural network architecture and machine learning may be used for accurate alignment between the visual and thermal frames. Each neuron transfer-function of the artificial neural network architecture is for example implemented by the following equation (equation 18):

Output=Sigmoid(Σᵤ₌₁^{Q}[wᵤiᵤ+b]) [Math 18]

where wᵤ are the weighting parameters, b is a bias, iᵤ are the inputs and Sigmoid( ) is the Sigmoid activation function.

The artificial neural network architecture for example comprises an input layer comprising a plurality of neurons, one or more hidden layers each comprising a further plurality of neurons, and an output layer comprising a further plurality of neurons that predicts the possible alignment. Those skilled in the art will be capable of training the artificial neural network to obtain an appropriate accuracy of the alignment performances or to detect, prior to the correlation calculations, an object in the visual frames which could help to enhance the rapidity of the calculations.

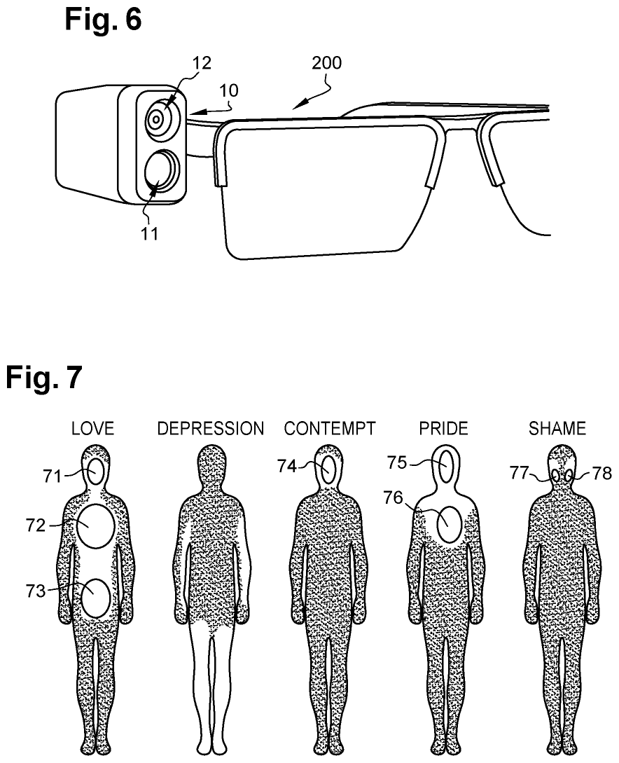

FIG. 6 schematically illustrates glasses equipped with a video imaging device according to an embodiment of the present disclosure.

In the example of FIG. 6, the glasses comprise a video imaging device 10 as described above, which is attached to the glasses. For example, the device 10 comprises a bracket permitting attachment to one of the temples of the glasses. This configuration could have many applications, including helping blind people for face and environment recognition, or helping diseases or virus detection, or even for security.

In another example, the glasses 200 further comprise sound sensors configured to determine a localization of a sound source. The video frame processing device 13 of the video imaging device 10 may be configured to determine an alignment between at least a first region of visual frames with respect to at least a first region of thermal frames and with respect to the localization of the said sound source. For example, the video imaging device 10 further comprising a directional microphone configured to adapt its direction of sound reception based on beam-forming, the video imaging device being configured to control the direction of sound reception based a location of a target identified in the visual frame or in an overlay frame. For example, the directional microphone is formed of an RF receiving array adapted to audio wavelengths. In some embodiments, the video frame processing device 13 is further coupled to ear phones, for example via a wireless interface such as a Bluetooth interface, and is configured to transmit an audio stream captured by the directional microphone to the ear phones. For example, in this way, a user of the glasses is able to tune into certain sounds by pointing the device 10 towards a sound source, such as a person or object. For example, the video frame processing device 13 is configured to identify a sound source, such as a speaker's mouth, a television set, etc., in the visual frames, and to adjust the direction of the directional microphone accordingly to target the sound source.

FIG. 7 represents infrared images of subjects at various states of emotion according to an embodiment of the present disclosure. For example, FIG. 7 illustrates an example embodiment of the present disclosure according to which the video frame processing device 13 is configured to determinate a state of emotion of one or more people or animals present in the first scene.

From an analysis of the alignment of at least the first region of the visual frames 20 with respect to at least the first region of the thermal frames 21, the video frame processing device 13 may be arranged to generate video frames where at least the first region of the visual frames 20 with respect to at least the first region of the thermal frames 21 are aligned. In the case where a person or an animal is present in the first region, it is possible to localize precisely the temperature flux flowing through the person. These temperature fluxes are each representative of a state of emotion and can therefore be related to an emotion. For example, emotions like love, hate, contempt, shame, pride or depression can be detected. This application may be useful in the study of behaviors for security reasons for example.

FIG. 7 represents in particular examples of the following emotions:

love (LOVE): characterized by a higher temperature in the face area 71, chest area 72, and groin area 73;

depression (DEPRESSION): characterized by relatively uniform and low temperature throughout the human body;

contempt (COMTEMPT): characterized by relatively uniform and low temperature throughout the human body, except in the face area 74, where the temperature is slightly greater;

pride (PRIDE): characterized by a higher temperature in the face area 75 and chest area 76; and

shame (SHAME): characterized by relatively uniform and low temperature throughout the human body, except in the right and left facial cheeks 77, 78.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. A video imaging device comprising:
at least one visual camera comprising at least one visual image sensor sensitive to visible light and configured to capture a first scene during a first capture period;
at least one thermal camera comprising at least one thermal image sensor sensitive to infrared light and configured to capture the first scene during the first capture period;
a video frame processing device configured to:
receive visual frames captured by the visual image sensor during the first capture period;
receive thermal frames captured by the thermal image sensor during the first capture period; and
determine an alignment between at least a first region of a first of the visual frames with respect to at least a first region of a first of the thermal frames based on correlation values representing correlations between pixels of the first visual and thermal frames.

2. The video imaging device of claim 1, wherein, prior to determining the alignment, the video frame processing device is configured to resize at least one of the visual frames and the thermal frames to have a same common size.

3. The video imaging device of claim 1, wherein the video frame processing device is configured to:
determine a plurality of first correlation values between first pixel values of pixels of the first region of one of the visual frames and first pixel values of pixels of the first region of a corresponding one of the thermal frames; and
determine the alignment based on a determination of an average correlation displacement parameter (τ) determined based on said correlation values.

4. The video imaging device of claim 1, wherein the video frame processing device is configured to:
partition each visual frame into macro-pixels (M[i,j]), each macro-pixel being generated based on a corresponding group of pixels (P[i,j]) of the visual frame;
determine a plurality of second correlation values between second macro-pixel values of macro-pixels (M[i,j]) of the first region of one of the visual frames and pixel values of pixels of the first region of a corresponding one of the thermal frames; and
determine the alignment based on a determination of an average correlation displacement parameter (τ) determined based on said second correlation values.

5. The video imaging device of claim 2, wherein the video frame processing device is configured to:
partition each visual frame into macro-pixels (M[i,j]), each macro-pixel being generated based on a corresponding group of pixels (P[i,j]) of the visual frame;
partition each thermal frame into macro-pixels (M[k,l]), each macro-pixel being generated based on a corresponding group of pixels (P[k,l]) of the thermal frame;
determine a plurality of second correlation values between second macro-pixel values of macro-pixels (M[i,j]) of the first region of one of the visual frames and second macro-pixel values of macro-pixels (M[k,l]) of the first region of a corresponding one of the thermal frames; and
determine the alignment based on a determination of an average correlation displacement parameter (τ) determined based on said second correlation values.

6. The video imaging device of claim 5, wherein the video frame processing device is configured to:
determine a plurality of third correlations values between pixel values of first and second pixels (P[i,j]) of at least one of the macro-pixels (M[i,j]) of the first region of one of the visual frames.

7. The video imaging device of claim 1, wherein the video frame processing device is configured to generate video frames where at least the first region of the visual frames are aligned with respect to at least the first region of the thermal frames.

8. The video imaging device of claim 1, wherein the video frame processing device is configured to:
determinate a state of emotion of a user placed in the first scene based on an analysis of the alignment of at least the first region of the visual frames with respect to at least the first region of the thermal frames.

9. The video imaging device of claim 1, wherein at least one of the correlation values result from cross-correlations determined based on the following equation:
$${nCC}_{{I}_{{S}_{1}} {I}_{S 2}} ( τ ) = \frac{{\int }_{-}^{+} {I}_{{S}_{1}} ( t ) {I}_{{S}_{2}} ( t + τ ) dt}{\sqrt{{\int }_{-}^{+} {\vert {I}_{{S}_{1}} ( t ) \vert}^{2} dt {\int }_{-}^{+} {\vert {I}_{{S}_{2}} ( t ) \vert}^{2} dt}}$$
where τ is the average correlation displacement parameter, I_{S}_{₁} is a matrix of pixel values of the first region of the visual frame, and I_{S}_{₂} is a matrix of pixel values of the first region of the thermal frame.

10. The video imaging device of claim 1, wherein at least one of the correlation values results from Cardinal-sine based calculations performed by the video frame processing device.

11. The video imaging device of claim 1, wherein the video frame processing device is configured to run a cross-entropy optimization of at least the aligned first region of the visual frames with respect to the first region of the thermal frames.

12. The video imaging device of claim 1, comprising a bracket permitting attachment of the video imaging device to one of the temples of a pair of glasses.

13. The video imaging device of claim 1, further comprising a directional microphone configured to adapt its direction of sound reception based on beam-forming, the video imaging device being configured to control the direction of sound reception based a location of a target identified in the first visual frame.

14. A pair of glasses comprising, attached to one of the temples, the video imaging device of claim 1.

15. The pair of glasses of claim 14, further comprising sound sensors configured to determine a localization of a sound source, the video frame processing device of the video imaging device being configured to determine an alignment between at least a first region of visual frames with respect to at least a first region of thermal frames and with respect to the localization of the said sound source.

16. A process of alignment of video frames, comprising:
capturing a first scene during a first capture period with at least one visual camera of a video imaging device comprising at least one visual image sensor sensitive to visible light;
capturing the first scene during the first capture period with at least one thermal camera of the video imaging device comprising at least one thermal image sensor sensitive to infrared light;
receiving, by a video frame processing device of the video imaging device, visual frames captured by the visual image sensor during the first capture period;
receiving, by the video frame processing device, thermal frames captured by the thermal image sensor during the first capture period; and
determining, by the video frame processing device, an alignment between at least a first region of a first of the visual frames with respect to at least a first region of a first of the thermal frames, based on correlation values representing correlations between pixels of the first visual and thermal frames.

17. The process of claim 16, wherein the video frame processing device is configured to:
determine a plurality of first correlation values between first pixel values of pixels (P[i,j]) of the first region of one of the visual frames and first pixel values of pixels (P[k,l]) of the first region of a corresponding one of the thermal frames; and
determine the alignment based on a determination of an average correlation displacement parameter (τ) determined based on said correlations.
